(19) United States
(12) Patent Application Publication
(10) Pub. No.: US 2003/0039525 A1
(43) Pub. Date: Feb. 27, 2003

(54) Lockable vehicle retaining apparatus

(76) Inventor: John C. Ankrom, Warsaw, OH (US)

Correspondence Address: ROBERT E. STEBENS, 6501 STRATHAVEN CT., N., WORTHINGTON, OH, 43085-2998, US

(21) Appl. No.: 09/939,944

(22) Filed: Aug. 27, 2001

(51) Int. Cl. B60P 3/06

(52) U.S. Cl. 410/3

(57) ABSTRACT

A lockable vehicle retaining apparatus is provided for securing of a vehicle such as a motorcycle to a conveyance vehicle or to a fixed position mounting structure. It comprises a base structure including a pair of horizontal, superposed plates, an elongated post secured at it's one end to the top plate and extending orthogonally upwardly therefrom terminating in an upper end and a vehicle connector secured to that upper end. Attachment devices extend through the bottom plate for securing an apparatus to either a conveyance vehicle or a mounting structure with their heads located between the plates where they cannot be accessed without the plates being separated. Separation of the plates is enabled by their pivotal interconnection along one edge by a hinge structure when the vehicle is not locked to the apparatus. The vehicle connector includes a pair of interfitting U-shaped brackets that receive a component of the vehicle in securing relationship. A locked device secures the brackets together. The post is axially reciprocable to enable the apparatus to accommodate vehicles of different sizes and is formed of two cooperative interlocking devices that prevent their separation.

### FIELD OF THE INVENTION

This invention relates to apparatus for retaining of a vehicle, or other mechanism, in secured relationship to a device or structure that is substantially immovable for reducing the possibility of it's unauthorized removal to parts unknown, namely, theft. It relates, more specifically, to an apparatus that is designed to be secured to a substantially immovable device or structure by means which effectively prevents it's removal therefrom when it is also secured to the vehicle. The apparatus is secured to the vehicle by a lock mechanism which can be selectively manipulated between locked and unlocked states by a person having the lock mechanism's actuating component.

### BACKGROUND OF THE INVENTION

Transport of sport vehicles such as motorcycles, snowmobiles and all terrain vehicles is generally effected by conveyance vehicles typified by the well known pick-up truck having an open-top cargo-carrying compartment mounted on the rear of the truck's chassis. These compartments on a truck of this nature are generally of sufficient size and capacity to contain one or more of the aforesaid types of vehicles in their conventional upright position. Restraining apparatus, such as flexible metal cables or chains, is commonly utilized to maintain the vehicle in an upright position and fixed location within the conveyance vehicle cargo compartment. Connecting devices associated with the cargo compartment in structurally fixed relationship thereto provide means whereby the cables or chains of the restraining apparatus may be attached between a vehicle and the cargo compartment in which it is positioned. This restraining apparatus not only performs the physical interconnection function but can also function to secure the vehicle against theft through inclusion of typical lock devices.

While restraining apparatus of this type performs the basic function of maintaining the vehicle in a fixed location and orientation in the conveyance vehicle's cargo compartment, it's capability to prevent theft has not been found to be particularly satisfactory. A thief need not spend time removing the lock device securing a cable or chain to a vehicle. The time required to effect theft of that vehicle can be minimized by the simple expedient of using a bolt cutter. The cables and chains utilized for this purpose are typically light duty to facilitate their use and, typically, they are not made from steel that is hardened to increase their capability to resist cutting. Consequently they may be readily cut by use of a bolt cutter.

### SUMMARY OF THE INVENTION

In accordance with this invention an apparatus is provided which comprises a structure which provides a means for secure retaining of a vehicle of this aforestated type to either a conveyance vehicle with a cargo compartment or to a structure that is fixed to a ground supporting surface. The apparatus includes a base structure which is designed to be affixed to the cargo compartment or to the ground supporting surface, an elongated post secured at it's one end to the base structure and extending orthogonally from the base structure and a vehicle connecting mechanism attached to the opposite end of the post. A locking device is provided for securing connecting mechanism to the vehicle and is typically a shackle-type lock provided with a key for it's actuation.

The base structure comprises a pair of plates that are connected along one side edge by a hinge structure having a first element secured to one of the plates and second element connected to the other plate whereby the plates may be pivoted relative to each other. These plates are disposed in superposed relationship with a first plate positionable in secured relationship to the cargo compartment or ground supporting surface by means of bolts. A elongated post has a first end attached to the upper surface of the second plate and has a vehicle connector secured to it's second end. This post is constructed of two components that are telescopically assembled to permit relative changes in the overall length of the post which extends perpendicularly to the base structure. The vehicle connector includes a U-shaped bracket that mechanically engages with a component of the vehicle to be secured. The locking device functions to secure the bracket to the vehicle. With a vehicle secured to the bracket, the plates of the base structure cannot be relatively pivoted. The locking device is secured in a position relative to the vehicle where it may not be cut by a bolt cutter.

A vehicle is secured to a mounting surface by the retaining apparatus. This mounting surface may be formed as a part of a conveyance vehicle or as a part of a support foundation. When formed as a part of conveyance vehicle it is usually the bed of the cargo compartment. When formed as a part of a support foundation it is generally the upper surface of that foundation which is positioned on the ground. Incorporated with the foundation may be a building structure that is of a size and configuration to receive and enclose the vehicle and, if desired, also enclose the conveyance vehicle having a vehicle positioned in it's cargo compartment. The objective is to provide protection for the vehicles from exterior environmental conditions which may adversely affect the vehicles.

It will become apparent from the following description of the apparatus with reference to the accompanying drawings that an apparatus is provided which is capable of securely retaining the vehicle to the cargo compartment of a conveyance vehicle or to a ground supporting surface.

### DESCRIPTION OF THE DRAWING FIGURES

FIG. 1 is a side elevational view of the lockable vehicle retaining apparatus embodying this invention.

FIG. 2 is a side elevational view of the apparatus as seen with the base portion placed in an open position.

FIG. 3 is an assembly drawing of the vehicle retaining apparatus.

FIG. 4 is an elevational view of the upper portion of a modified retaining apparatus.

FIG. 5 is an elevational view of the apparatus when it is secured to a vehicle and is mounted on a supporting structure that is a ground positioned foundation with an upper surface on which a vehicle is positioned when the apparatus is secured to the vehicle.

FIG. 6 is an elevational view of the apparatus secured to a vehicle and attached to a supporting structure having an upper surface that is a part of a conveyance vehicle with the vehicle standing on that surface.

FIG. 7 is a perspective view of the apparatus attached to a vehicle and positioned within a protective building structure having a foundation slab positioned on the ground with portions of the building structure broken away for clarity of illustration of a vehicle located therein and locked to the vehicle retaining apparatus.

FIG. 8 is an elevational view of a modified apparatus in combination with a component of a vehicle that is locked thereto.

FIG. 9 is a perspective view of the apparatus as seen on an upper surface of a supporting structure on which a vehicle is positioned with the apparatus secured to a diagrammatically illustrated vehicle.

### DESCRIPTION OF THE ILLUSTRATIVE EMBODIMENTS

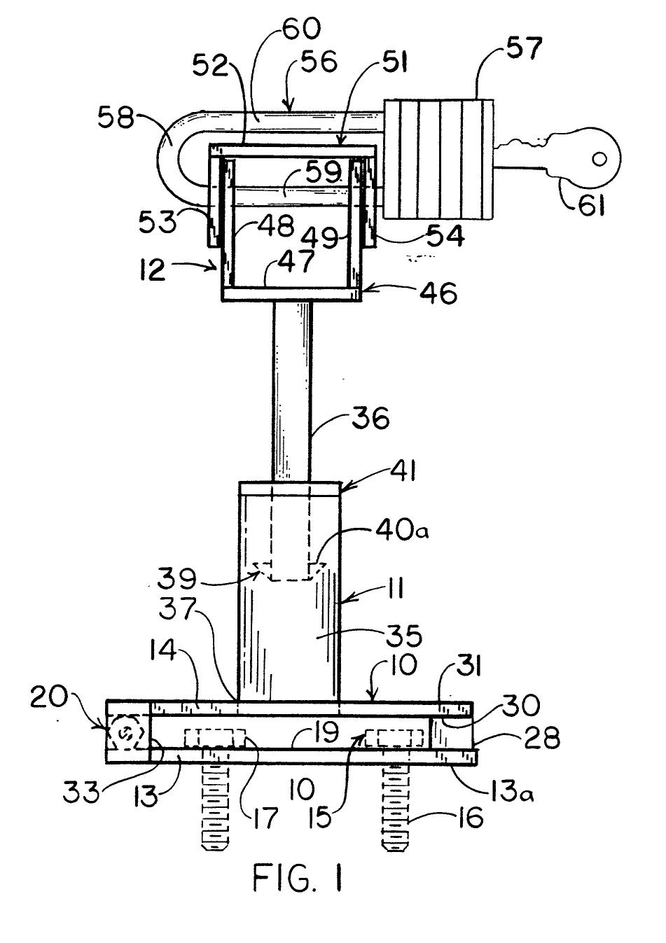

Referring to the drawings; specifically, FIGS. 1, 2 and 3, an embodiment of the lockable vehicle retaining apparatus LVRA is shown. This apparatus comprises a base structure 10, an elongated post 11 and vehicle connector 12. The base structure is adapted to be secured to a mounting structure which is not shown in these drawing figures but is shown in other figures of the drawings. The base structure includes first and second plates, 13 and 14, of planar configuration that are of square shape and disposed in superposed relationship. When positioned on a mounting structure ST, the first plate is placed with it's outer or bottom surface 13a in contacting engagement with an upwardly facing surface S of that mounting structure ST which is diagrammatically illustrated in FIG. 1. It is secured to that structure by a plurality of fastening devices such as bolts 15 having elongated screw-threaded shafts 16 with a bolt head 17 integrally formed with each shaft. These bolts are shown in broken lines to indicate they typify a type of fastening device which may be utilized. The first plate 13 is provided with a number of circular apertures 18 disposed in relatively spaced relationship over the upper surface 19 of the first plate 13 whereby the bolt heads will overlie that surface and function to clamp the plate to the mounting structure at a desired position.

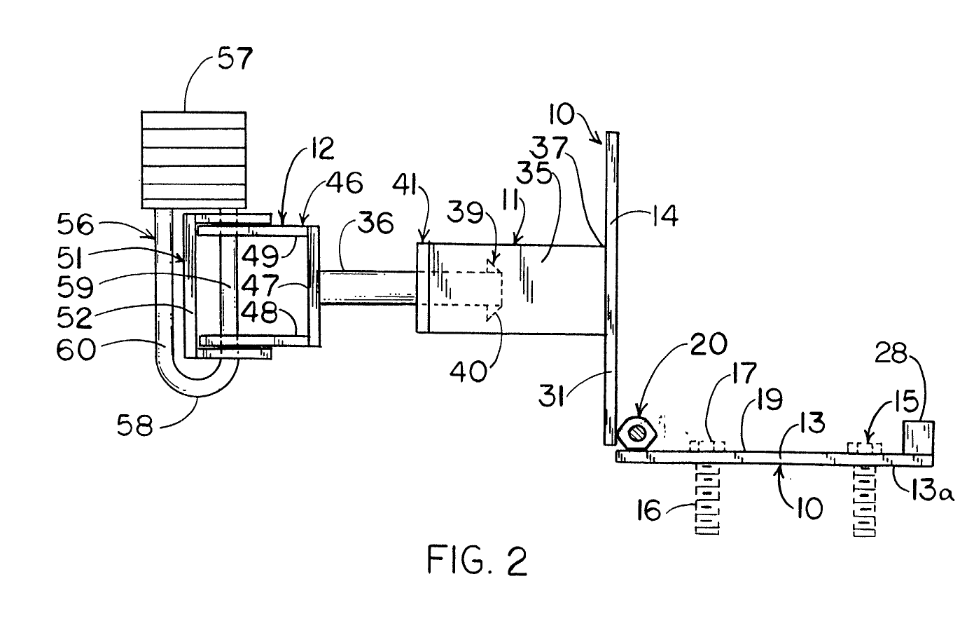

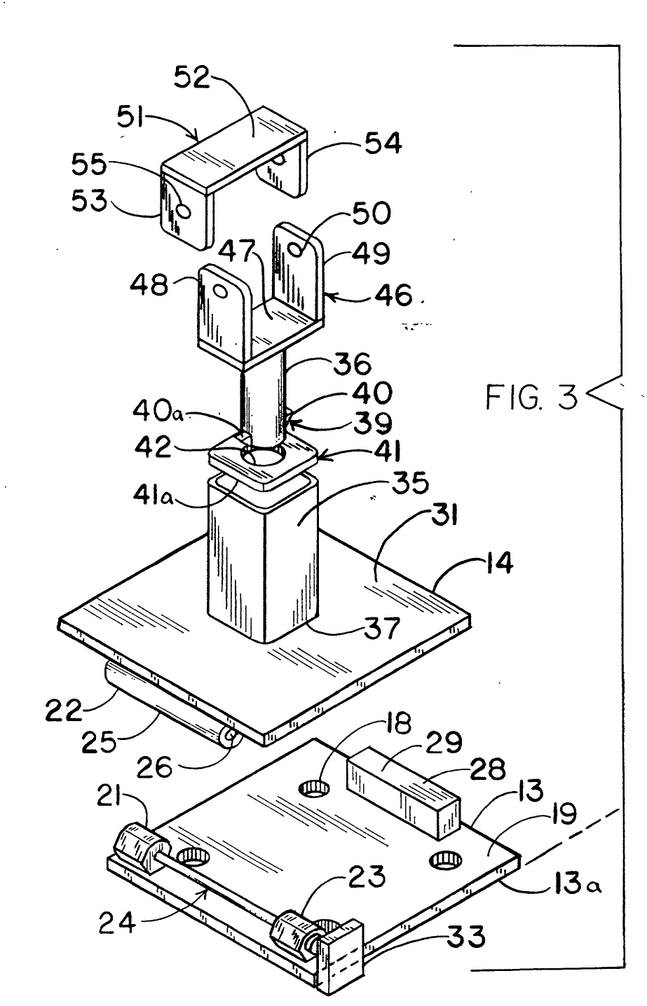

These two plates 13 and 14 are interconnected along one side edge by a hinge structure 20 which includes a first element 21 that is secured to the first plate 13 and a second element 22 that is secured to the second plate 14. In this embodiment the first hinge element includes a pair of socket elements 23 disposed in spaced apart, coaxially aligned relationship and a hinge pin 24 that is fixed in the socket elements. This hinge pin has one end formed with a flared or enlarged diameter end 24a to prevent the hinge pin from being pulled out of the socket elements 23. The second hinge element comprises a cylindrical tube 25 that is secured to the plate 14 throughout it's length and having an elongated hole 26 extending coaxially therethrough and which receives the hinge pin 24 in relatively rotatable engagement. A stop plate 27 is welded to the base plate 13 at a position adjacent the flared end 24A of the hinge pin 24. It extends upwardly terminating in a top edge portion 27a that overlies the edge of the top plate 14 thereby preventing the hinge pin 24 from being pulled out of the hinge assembly. The hinge structure is located adjacent one of the longitudinal edges of the two plates whereby the second plate 14 may be pivoted upwardly as shown in FIG. 2 resulting in exposure of the upper surface 19 of the first plate. This enables the bolts 15 to be inserted through their respective apertures 18 formed in the first plate for securing the apparatus to a supporting structure (not shown). When the second plate 14 is returned to it's horizontal position as shown in FIG. 1, that plate then overlies the bolt heads 17 and prevents the bolts from being removed. Attached to the upper surface 19 of the first plate is a spacing element 28 which functions to maintain the two plates in parallel relationship. The spacing element is positioned adjacent the side of the plate opposite the hinge structure 20 as can best seen in FIG. 3. It comprises an elongated bar having an upper surface 29 against which the bottom surface 30 of the second plate rests. Each of the hinge structure's two socket elements 23 is formed from a short section of a bar that is of hexagonal shape in cross section. This results in having a flat surface facilitating welding of the element in a fixed position on the plate 13. Referring to FIG. 3 it will be noted that two of the corners of the elements 23 are rounded to be coaxial with the cylindrical surface of the second hinge element 22 thereby enabling the top plate to be revolved.

The elongated post 11 includes two telescopally interfitting components 35 and 36. The first component 35 consists of an elongated tube of square cross-section having a first end 37 secured to an upper surface 31 of the second plate 14 and is disposed in orthogonal relationship to that plate. The component 36 is an elongated cylindrical shaft having a first end portion that extends into the central area of the first component 35 and is coaxially aligned relative thereto. Formed on the first end portion of the shaft 36 is a stop element 39 that functions to prevent extraction of the shaft from the tubular component 35. As can be seen in FIGS. 1, 2 and 3 this stop element includes a pair of lugs 40 which project a distance radially outward from the shaft. Secured to the upper end of the tubular component 35 is a retainer plate 41 formed with a central circular aperture 42 having a diameter which is sized to closely receive the cylindrical shaft 36. Each of the stop element lugs 40 comprises a triangularly shaped plate having horizontal upper surfaces 40a that may engage with the bottom surface 41a of the retainer plate. By forming the post to be telescopically displaced enables it to be adjusted in length and thereby permit the apparatus to accommodate different types or sizes of vehicles.

The vehicle connector 12 is secured to the second or upper end of the cylindrical shaft 36 and comprises a U-shaped bracket 46 having an elongated base plate 47 which is attached to the shaft. A pair of lugs 48 and 49 of plate-form are secured to the opposite ends of the base plate in spaced parallel relationship and extend radially upward relative to the shaft 36. An aperture 50 is formed in each of the lugs adjacent their outermost ends in coaxially aligned relationship. This connector 12 is sized and configured to cooperatively receive a component of a vehicle that is to be retained by the apparatus.

A second U-shaped bracket 51 is provided to be disposed in overlying relationship to the first bracket 46 and includes elongated base plate 52 and a pair of lugs 53 and 54 secured to the base plate in spaced parallel relationship. Apertures 55 are formed in each of the lugs adjacent their outermost ends on coaxially aligned relationship. The bracket 51 is dimensioned so that it's lugs will receive the lugs 48 and 49 of the first bracket in close interfitting engagement with their respective apertures 50 and 55 in cooperative alignment. It will be noted that the second bracket is configured to position it's base plate 52 in contacting engagement with the upper end surfaces of the lugs 48 and 49 and minimize the distance that the plate is spaced from the base plate of the first bracket.

A locking device 56 is provided for securing the two brackets 46 and 51 in interconnected engagement as seen in FIGS. 1 and 2. This locking device comprises a typical shackle lock having a base mechanism 57 and a U-shaped shackle 58 which includes a pair of spaced parallel shafts 59 and 60. These shafts are positioned with one shaft 59 extending through the apertures 50 and 55 that are formed in the lugs of the respective brackets. The other shaft 60, when the locking device is positioned as shown in FIGS. 1 and 2, extends in overlying relationship to the upper surface of the second bracket's base plate 52. Shaft 60 is rotatably fixed in the base mechanism and can be axially displaced a short distance outwardly from the base mechanism. The other shaft 59 is adapted to be inserted in a socket in the base mechanism where it is releasably held by the lock structure. A locking element 61 such as a key is provided for actuating the lock structure and is selectively inserted in the base mechanism to effect actuation of the lock structure or to be removed therefrom. When the lock structure is actuated to release the shaft 59 that shaft can be axially displaced out of the base mechanism there-by permitting the base mechanism to be rotated on the shaft 60 to a position that will permit it to be moved over the top of the second bracket 51. This enables the shaft 59 to then be withdrawn from the interconnected brackets thereby releasing a vehicle that had been secured by the connector. The lugs 48 and 49 are of a length to enable a component (not shown) to extend between those lugs and the opposed base plate 47 and the shaft 59 of the shackle lock.

The components of the apparatus are fabricated from relatively thick metal to provide adequate structural strength for retaining a vehicle. Additionally, the structure is fabricated to effectively prevent it from being readily destroyed by a thief.

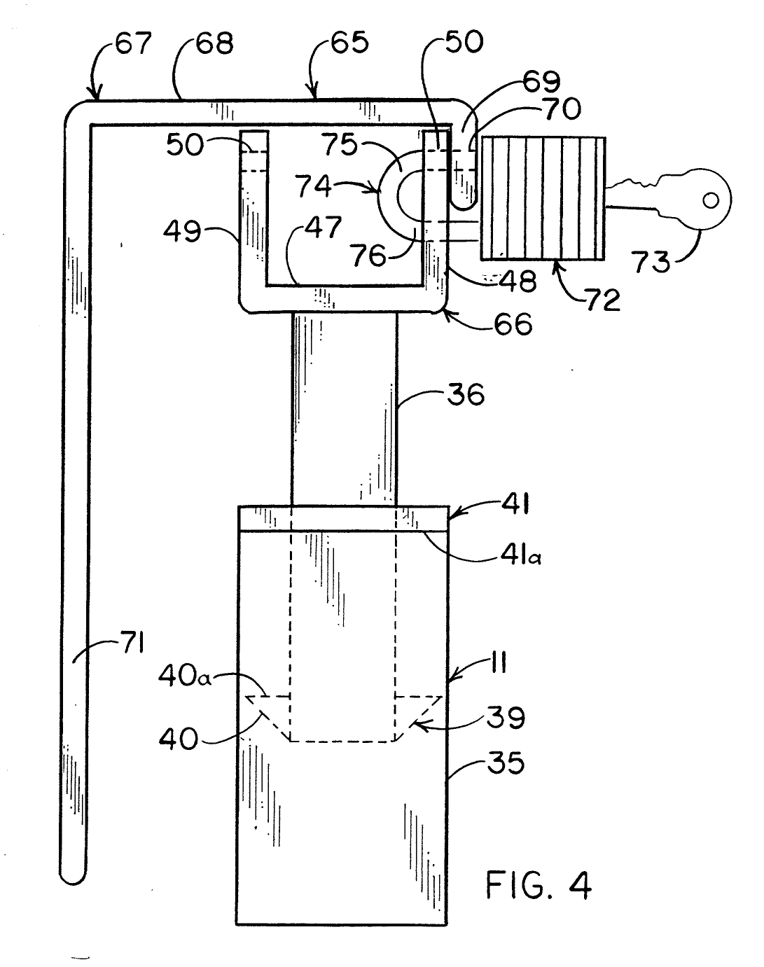

Referring to FIG. 4, a retaining apparatus embodying this invention is shown having a modified vehicle connector 65. This connector is the only structural difference with respect to the previously described retaining apparatus. Consequently, only the upper portion of this embodiment is shown in this drawing and described herein. It includes a first bracket 66 that is similar to the previously described bracket 46 and includes a base plate 47 and a pair of lugs 48 and 49. The base plate is attached to the upper end of the cylindrical shaft 36 of the telescopic post 11 and is also disposed in a horizontal plane with it's lugs projecting vertically upward from respective opposite ends thereof. The second bracket 67 includes a base plate 68 disposed horizontally across the top ends of the first bracket's lugs in parallel relationship to it's base plate and having a first lug 69 which is disposed closely adjacent to the exterior surface of the lug 48 of the first bracket and includes aperture 70 that is located to be coaxially aligned with the aperture 50 in the lug of first bracket. The base plate 68 is of a length to extend a distance laterally outward with respect to the first bracket and the post 11 with the second lug 71 formed at it's outermost end. This lug 71 is of a length to extend substantially down to the upper plate 14 of the base structure 10. It is configured to interfit with a component of a vehicle which is to be retained with that diagrammatically illustrated component C shown confined in the L-shaped space of the bracket in cooperation with the post 11. A shackle lock 72 is provided for securing the two brackets together and includes a locking device 73 and a U-shaped shackle 74 having a pair shafts 75 and 76. This shackle is configured to only engage with the first lug 69 and the associated lug 48 of the first bracket. This locking device functions in the same manner as the previously described locking device.

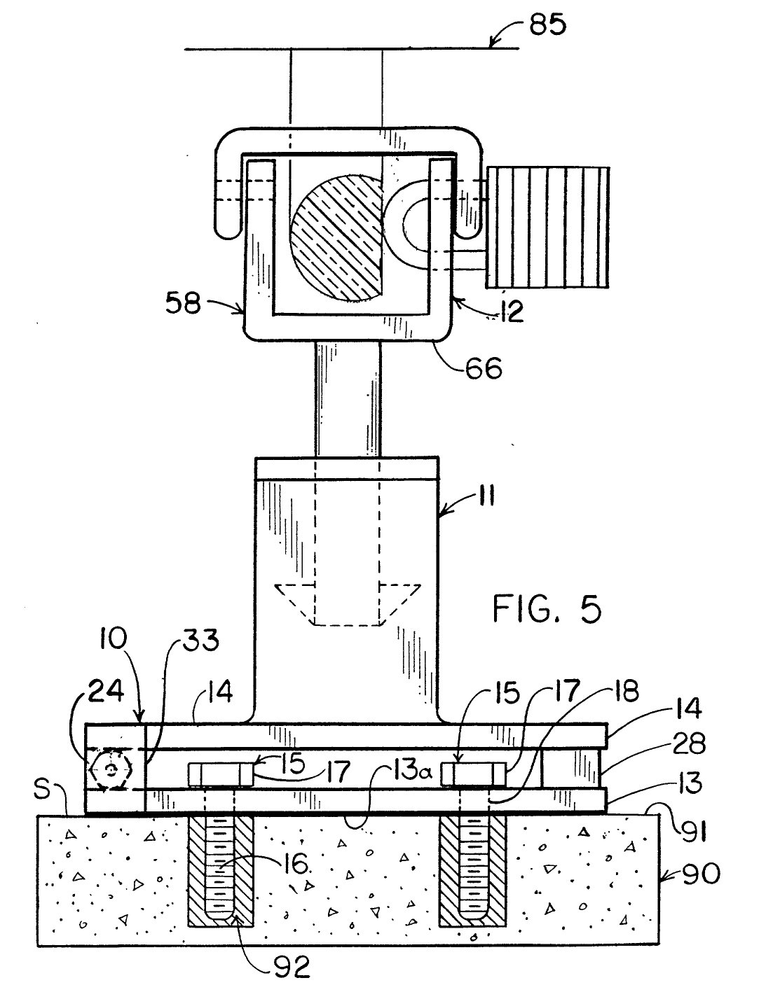

A modification in the attachment of the connector 12 to a vehicle generally designated by the numeral 85 is shown in FIG. 5. The connector includes a U-shaped bracket having a base plate 47 with respective brackets 48 and 49 projecting upwardly therefrom. A second U-shaped bracket is positioned on top of the first mentioned bracket with a component C of the vehicle extending through the space formed by those two brackets. A shackle-type locking device 77 having a U-shaped shackle 78 is utilized to secure the two brackets together. One leg a of the shackle extends through coaxially aligned apertures 79 formed in the legs of the brackets.

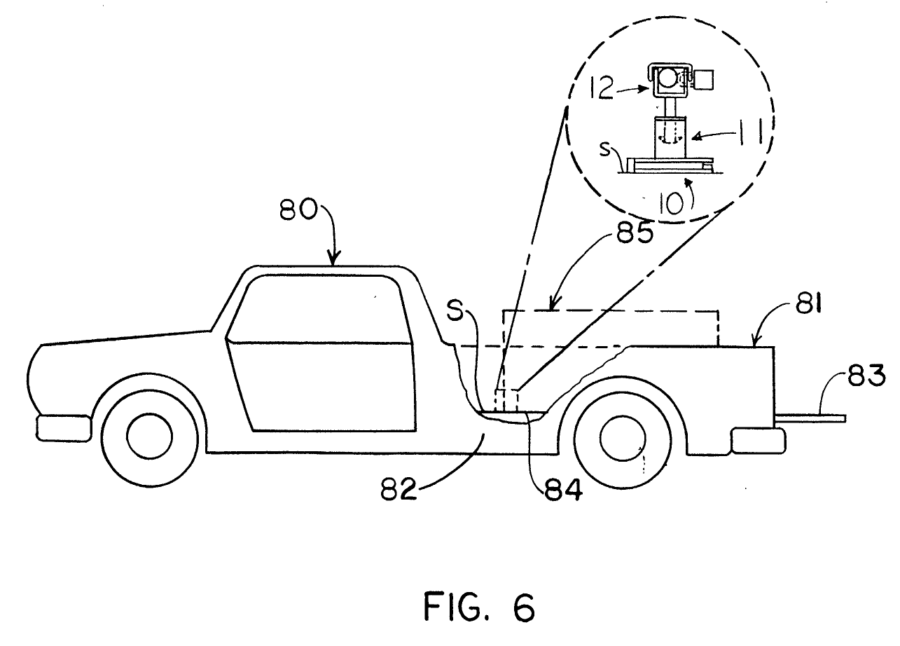

Utilization of the retaining apparatus LVRA is shown in FIG. 6 with the apparatus being mounted on a supporting surface that is incorporated with and formed as the upper surface of mounting structure S that is an integral part of a conveyance vehicle 80. This conveyance vehicle is a typical pickup truck having a cargo compartment 81 mounted on the rear of the truck's chassis. Such a cargo compartment is formed with a bed that is enclosed within peripheral side walls 82 that includes a tail gate 83 with the mounting structure S being the bed of the cargo compartment and having an upper supporting surface 84. The base plate 13 of the base structure 10 is positioned with it's bottom surface 13a mounted in contacting engagement on the upper surface 84 of the cargo compartment's mounting surface. It is located at an appropriate position where the apparatus will be able to be connected with a vehicle 85 such as a motorcycle. The bolts 15 are extended through the apertures 18 formed in the first plate 13 and projected through the bed of the cargo compartment 81 and having cooperating nuts threaded thereon under the bed. While only one retaining apparatus and vehicle retained thereby is shown FIG. 6, there could be one or more additional retaining apparatus with their associated vehicles depending upon the size and type of conveyance vehicle 80.

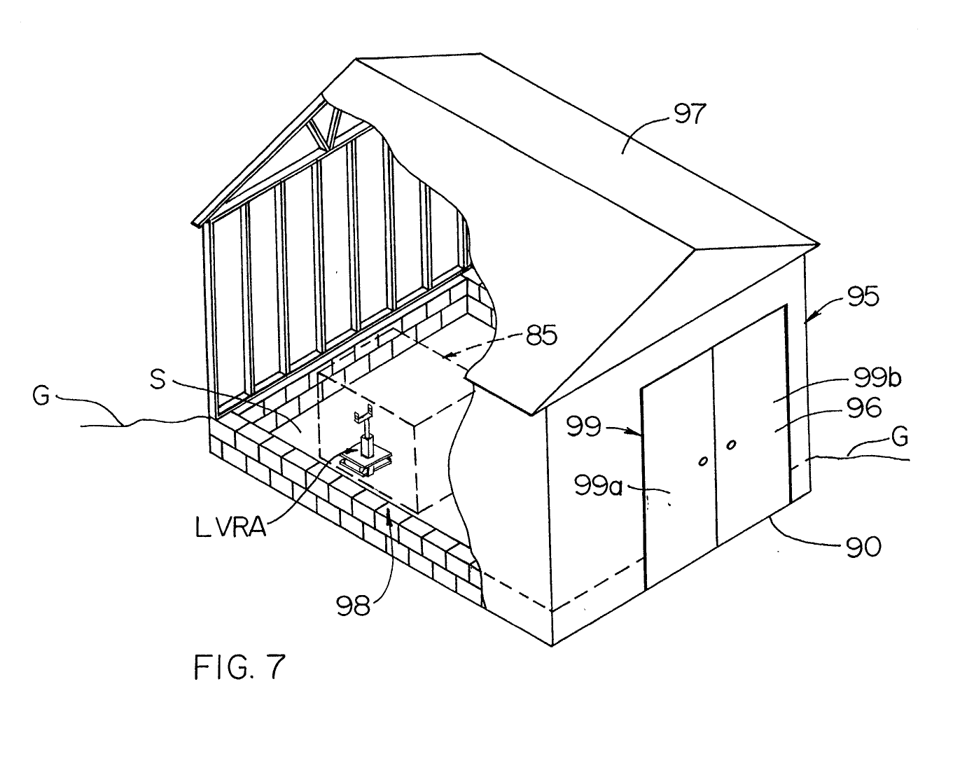

Again referring to FIG. 5, the mounting structure S may comprise a concrete slab 90 that is positioned on the ground which is generally designated as G. This concrete slab has a supporting surface 91 at it's upper side with the retaining apparatus LVRA secured to the slab on this surface. This is accomplished by having threaded metal sockets 92 embedded therein in fixed engagement and which are adapted to receive the threaded bolts 15. A vehicle 85 which is secured by the vehicle connector 12 is thus secured to this foundation. The foundation is of a size and weight such that it can not be readily moved, particularly with the added weight of a vehicle that may be positioned on the slab and locked to the retaining apparatus. This concrete slab 90 may be incorporated as a part of a building structure 95 such that shown in FIG. 7. This building structure is shown in perspective with portions broken away for clarity of illustration of a lockable vehicle retaining apparatus LVRA and a vehicle 85 locked thereto located within the building. Depending upon the size of the building structure more than one retaining apparatus with a respective vehicle locked thereto can be placed within a same building. The building structure includes peripheral walls 96 and a roof 97 with the walls secured to the top of a perimeter foundation wall 98 and extending vertically upward therefrom. The concrete floor slab 90 is formed on the ground within the perimeter foundation wall 98 having it's upper vehicle supporting surface 91 essentially coincident with the top of the foundation wall. Mounted in an end wall of the building is a door assembly 99 having two door sections 99a and 99b of adequate width to permit passage of a vehicle therethrough. The terrain surrounding the building structure has an upper surface GS with the portion adjacent the door being at the same level as the surface 91 of the foundation slab 90. A lockable vehicle retaining apparatus LVRA embodying this invention is mounted on the foundation slab at a location where it may be pivoted between it's two positions as shown in FIGS. 1 and 2 in addition to being locked to a vehicle such as an ATV. This building structure provides protection from environmental elements that may be prevalent exteriorialy of the building and may have an adverse effect on the vehicle.

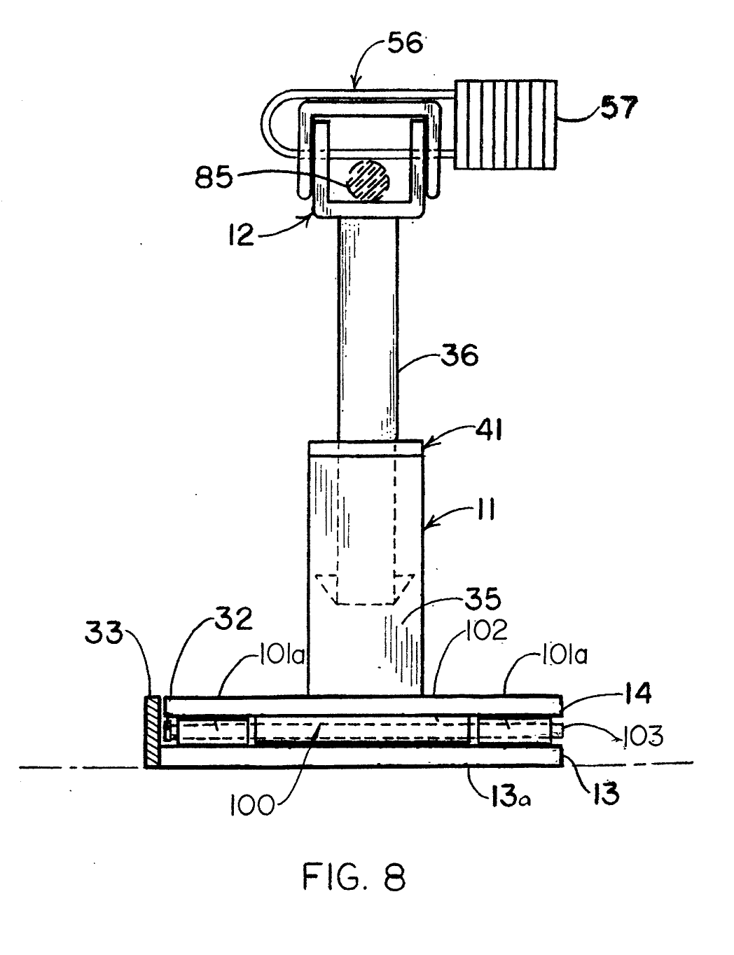

A modification of the lockable vehicle retaining apparatus LVRA of this invention in operating combination with a tubular cylindrical frame-component FC of a vehicle is shown in FIG. 8. Elements of this modificatiion that correspond to a same element of the apparatus embodiment shown in FIGS. 1-3 are similarly described and numerically identified by the same number. The vehicle's frame-component typifies a portion of a motorcycle's structural frame such as an elongated tube at the lower side of the frame and extending longitudinally of the motorcycle intermediate it's front and rear wheels. To effect locking of a motorcycle to the retaining apparatus, the motorcycle is first manuvered to a position where it's frame-component FC is located vertically above the vehicle connector 12 of the apparatus which is mounted on a mounting structure S at it's upper surface 91. It will be understood that the apparatus is oriented in an upright position at this time and that the connector assembly with it's shaft 36 will be in a lower most position with the shaft resting on the plate 14. Prior to manuvering the vehicle over the apparatus, the locking device 56 will have been removed along with the bracket 46. With the motorcycle in position, the shaft 36 is raised upwardly to place the bracket 46 in receiving engagement with the frame-component and the other bracket is then placed over the top of the upwardly-opening thereby cooperatively entrapping the frame-component. The free-ended shaft 60 of the locking device's shackel 58 is then projected through the aligned coaxial apertures 55 in the overlapping ends of the respective lugs of the two brackets. The shackle's other shaft 59 will then be overlying the top of the base plate 52 and sliding the base mechanism 57 over the bracket to a position where it may be rotated to a position where the other shaft 60 may be inserted into and locked in the base mechanism. This completes locking of the motorcycle to the apparatus. Release of the motorcycle from the apparatus LVRD for free movement to another location is effected by an obvious reversal in the operations and the sequence in which they are performed with respect to that of the previously operation for effecting locking of a vehicle to an apparatus for it's retention at a fixed location.

It will be noted that this same functional operation of an apparatus LVRD embodying this invention is applicable to vehicles other than motorcycles. It can be used with ATVs and snowmobiles as well as any other vehicle regardless of whether it includes it's own means of propulsion. For example, it may be used to retain a trailer in locked relationship. The basic requirement is that the vehicle have a structural component which can be engaged by the bracket or brackets of the apparatus in locked relationship.

This modification shown in FIG. 8 structurally differs from that shown in FIG. 1 by the hinge structure 100 that secures the two plates 13 and 14 together. This hinge structure primarily differs in being smaller in transverse direction resulting in the plates 13 and 14 being placed closer together with this reduction in spacing being limited by the thickness of the bolt heads as can be seen by reference to FIGS. 1 and 2. It comprises a first hinge element 101 and a second hinge element 102 with the first hinge element comprising a pair of tubes 101a disposed in longitudinally spaced, coaxially aligned relationship and the second hinge element being an elongated tube 102a disposed between the two tubes of the first hinge element in coaxial alignment. Each of the hinge elements has an axially extending, centrally located, cylindrical bore and which are in coaxial alignment. An elongated hinge pin 103 of cylindrical rod-form extends axially through the central bores of the aligned hinge element tubes and enables them to be relatively rotated. It is of a diameter that closely approximates the internal bore diameters of the hinge element tubes 101a and 102a. The hinge structure 100 is positioned closely adjacent one side of the base structure plates 13 and 14 to enable the upper plate 14 to pivot to an upwardly directed position simular to that shown in FIG. 2. When thus positioned, the heads of the apparatus attaching bolts are exposed to permit access to them for enabling their removal from the mounting structure S along with the apparatus LVRA. This functional operation can be clearly understood by reference to FIG. 2. Alternatively, the operation can be reversed to accomplish mounting of the apparatus on a mounting structure.

Each of the first hinge element's tubes 101a is positioned on and secured to the first plate's upper surface 19 in parallel relation to the side edge 104 of the plate with it's outer end close to the respective adjacent side edge 105 and 106. These tubes are welded to the plate at a location where their outer peripheral surface has a portion that is at least coextensive with the plate's side edge 104 if not extending a slight distance outwardly therefrom. The second hinge element's tube 102a is welded to the plate 14 parallal to it's side edge 107 and is also located so that at least a portion of it's outer peripheral surface is coextentive with the edge 107 if not extending a slight distance outwardly therefrom. These tubes are positioned in coaxial alignment and are welded to their respective plates 13 and 14 so that they will be slightly spaced from the surface of the opposite plate. With the hinge pin 103 extending through the central bore of the hinge elements 101a and 102a, the plate 14 may then be revolved between the horizontal and vertical positions. An enlarged head 108 is formed on one end of the hinge pin and is covered by the stop plate 33 which prevents one from removing the pin from the hinge structure.

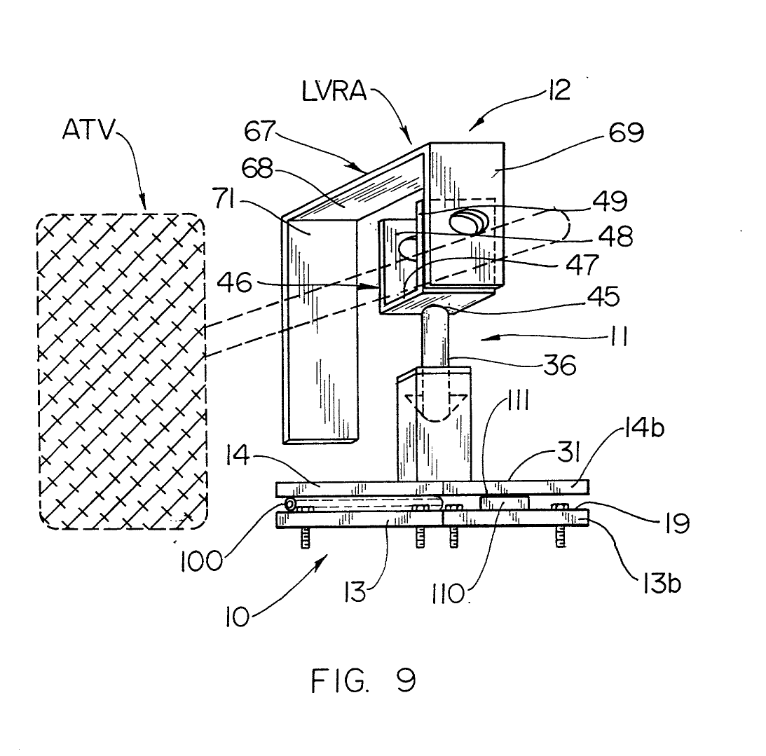

A perspective illustration of the apparatus LVRA is shown in operative combination with a fragmentary portion of a diagramatic illustration of an ATV in FIG. 9. The apparatus is not shown in true perspective in that the base structure 10 is shown in elevation for clarity of illustration with a minimum of drawing figures. This does not detract from a clear understanding of the structure. This base structure is similar to that shown in FIG. 8 but as seen looking at the corner of the plates 13 and 14 with the side at the left being the one that is next adjacent the one which is associated with the hinge structure 100. At the right of this illustration of the base structure are the side edges 13b and 14b of the respective plates and located diametrically opposite the side edges associated with the hinge structure. A spacing element 110 is secured to the upper surface 19 of the plate 13 and is of a vertical dimension equal to that of the hinge structure whereby it will hold the plates parallel. It has an upper surface 111 on which the plate 14 rests but to which it is not secured.

An elongated post 11 is secured to the upper surface 31 of the second plate 14 and extends vertically upward therefrom. This post is of a telescopic construction similar to that of previously described embodiments of the apparatus LVRA with specific reference being made to that which is shown in FIG. 4. Secured to the upper end of the shaft 36 is a vehicle connector 12 having an upwardly opening U-shaped bracket 46 with a base plate 47 that is welded at it's longitudinal center to the upper end 45 of the shaft 36. Formed at the opposite ends of the base plate are respective upwardly extending lugs 48 and 49 which interact with the second bracket 67. This second bracket is also U-shaped but it is oriented in a downwardly opening position. It has a horizontally disposed, elongated base plate 68 that lies parallel to the base plate 47 of the other bracket with lugs 69 and 71 formed at it's respective opposite ends.

It will be readily apparent from the foregoing description and the accompanying drawings that a lockable vehicle retaining apparatus is provided by this invention. This apparatus includes a base structure, an elongated post and a vehicle connector secured to the upper end of the post and which may be securely locked to a vehicle. The apparatus is of a construction that resists removal of the vehicle by a thief. Additionally, the apparatus may be secured to a conveyance vehicle or to a foundation structure that may be positioned by itself on the ground or incorporated in a protective building structure. Regardless of whether the apparatus is secured to a conveyance vehicle or to a foundation structure, the vehicle locked to the apparatus will be positioned with it's ground engaging propelling component, either a rotatable drive wheel in the case of a motorcycle, or multiple drive on an ATV, or the revolvable and elongated endless drive track of a snowmobile, along with other ground engaging, stabilizing components such as additional wheels or ski-like runners. When so equiped the vehicle locked to the retaining apparatus also functions to prevent the upper plate of the base structure being pivoted to a vertically upright position relative to the bottom plate thus prohibiting removal of the apparatus attaching bolts.

1. A lockable vehicle retaining apparatus comprising
(A) a base structure adapted to be secured to a mounting structure on a surface thereof and which includes a first plate and a second plate disposed in superposed relationship with said first plate having a surface that is positionable on the mounting structure's surface in contacting engagement therewith, said plates being of planar configuration with said second plate having at least one peripheral edge portion that is linear, said plates interconnected by a hinge structure having first and second hinge elements that are rotatably connected together along a hinge axis with these elements each being secured to a respective plate with the hinge element secured to said second plate at a position closely adjacent it's linear edge portion with the hinge axis parallel thereto thereby enabling said plates to be rotatably pivoted relative to each other;
(B) an elongated post having first and second ends with the first end being secured to said second plate at it's upper surface, said post disposed in laterally outward extending relationship to said plate's surface and oriented substantially orthogonally relative thereto; and
(C) a vehicle connector adapted to be removably mechanically interengaged with a component of the vehicle and secured to said post at it's second end, said connector including a locking device that is operable in cooperation therewith for securing said connector to the vehicle and having a selectively operable locking element which is removable from said device.

2. A vehicle retaining apparatus according to claim 1 wherein said base structure's first plate is removably attachable to a mounting structure's surface.

3. A vehicle retaining apparatus according to claim 2 wherein said plate is attached by a plurality of bolts formed with elongated shanks having an enlarged head at one end thereof disposed in relatively spaced relationship to each other around said plate which has an aperture formed therein for each bolt and through which a bolt's shank extends leaving the head overlying the plate's surface intermediate said first and second plates.

4. A vehicle retaining apparatus according to claim 3 wherein said hinge structure is constructed to enable the plates to be disposed in spaced parallel relationship to accommodate the bolt's heads therebetween in substantially clamped engagement.

5. A vehicle retaining apparatus according to claim 1 wherein said post is of a telescopic construction enabling it's length to be changed to accommodate different types of vehicles.

6. A vehicle retaining apparatus according to claim 5 wherein said post includes an elongated tube and an elongated shaft which telescopically interfit coaxially, said tube and shaft having opposite first ends that are secured to respective ones of said base structure's second plate and to said connector assembly and having second ends that interfit with respect to each other, said tube and shaft provided with cooperative interlock means that limits their axial displacement relative to each other and thereby prevents them from becoming separated.

7. A vehicle retaining apparatus according to claim 6 wherein said interlock means includes a retainer plate attached to said tube in axially spaced relationship to it's first end, said shaft having at least one retaining element attached adjacent to it's second end having the end portion projecting interiorly of said tube and extending a distance radially outward therefrom, said retainer plate having an aperture that is configured to receive said shaft in closely spaced relationship thereby preventing passage of said retaining element therethrough.

8. A vehicle retaining apparatus according to claim 7 wherein said shaft is cylindrical and said retainer plate's aperture is cylindrical to cooperatively engage with said shaft in axially sliding engagement and permitting their relative rotation.

9. A vehicle retaining apparatus according to claim 7 wherein said retainer plate is secured to said tube at it's second end.

10. A vehicle retaining apparatus according to claim 1 wherein said vehicle connector comprises a U-shaped bracket having a base plate secured to the second end of said post and a pair of lugs secured to said base plate adjacent respective opposite ends thereof and extending in an axially outward direction for receiving and supporting a component of a vehicle.

11. A vehicle retaining apparatus according to claim 10 wherein said locking device is a shackle lock having a lock base that incorporates the lock mechanism and a U-shaped shackle having two shafts extending from the lock base, one of said shafts extending through an aperture formed in at least one of said lugs, said lock base receiving said shafts and operable to engage one of said shafts in rotatable engagement and enable it to be axially displaced a limited distance from said lock base and to releasably engage the other of said shafts and enable it to be axially displaced out of said lock base.

12. A vehicle retaining apparatus according to claim 11 wherein said shackle lock's two shafts that are of length to extend across both of said lugs U-shaped bracket, each of said lugs having an aperture formed therein in transversely aligned relationship and through which one of said shackle's shafts extends.

13. A vehicle retaining apparatus according to claim 12 wherein said vehicle connector includes a second U-shaped bracket having a base plate and a pair of lugs secured to said base plate in orthogonally disposed relationship and spaced a distance apart to closely interfit with the lugs of the other U-shaped bracket, each of said lugs having an aperture formed therein in transversely aligned relationship for receiving the shaft of said shackle that extends through the lug aperture's of said bracket that is secured to said post.

14. A vehicle retaining apparatus according to claim 11 which includes a second U-shaped bracket having a base plate and a pair of lugs secured to said base plate ends in orthogonal orientation, said lugs spaced apart a distance to receive the lugs of the first bracket in contacting engagement, said shackle lock's shafts being of a length to extend through only one lug of said bracket secured to said post and one lug of a U-shaped bracket that is positioned in coupled relationship thereto thereby maintaining the lock mechanism in tightly disposed engagement with said lugs.

15. A vehicle retaining apparatus according to claim 1 wherein said base structure includes a spacer block secured to one of said first and second plates on a surface thereof in opposing relationship to a surface of the other of said plates, said block disposed adjacent the side of said plates opposite the side at which said hinge axis is located and having a surface that is disposed a predetermined distance from the surface of the plate on which said block is secured with said block's surface adapted to engage the opposed surface of the other plate thereby maintaining said plates in spaced apart relationship.

16. A vehicle retaining apparatus according to claim 1 which includes in combination therewith a vehicle that is retained in locked engagement with said vehicle connector, said vehicle having a component that is mechanically secured with said vehicle connector.

17. The combination of claim 16 wherein said vehicle connector's locking device includes a shackle lock having two shafts with one of said shafts adapted to mechanically interconnect with said locking device, said vehicle connector having a U-shaped bracket including a base plate and a pair of spaced apart lugs secured to said base plate disposed to open upwardly to receive said vehicle component therein between it's lugs, said lugs being of a length to extend above said vehicle component and having respective apertures formed in their upper ends in coaxially aligned relationship for receiving said shackle shaft therethrough in overlying relationship to said vehicle component.

18. A vehicle retaining apparatus according to claim 1 and including in combination therewith a vehicle that is retained in locked engagement with said vehicle connector and a mounting structure to which said retaining apparatus is secured.

19. The combination of claim 18 wherein said mounting structure includes a mounting surface, said retaining apparatus and said vehicle being positioned on said surface.

20. The combination of claim 19 wherein said mounting surface is incorporated in a conveyance vehicle.

21. The combination of claim 19 wherein said mounting surface is incorporated in a support foundation that is positioned on the ground.

22. The combination of claim 21 wherein said mounting surface's support foundation is incorporated in a building structure that is of a size and configuration to contain said vehicle therein and provide protection for said vehicle from environmental conditions prevalent exteriorly of said building structure and which may adversely affect said vehicle.

23. A vehicle retaining apparatus according to claim 1 wherein said vehicle connector includes a first bracket having an elongated base plate that is attached to said post at it's second end and at least one lug secured to said base plate and extending a predetermined distance axially outward relative to said post, a second bracket of U-shaped configuration having an elongated base plate and first and second lugs secured to said base plate in spaced apart relationship with each lug being of respective lengths and extending from a same side of said base plate in generally orthogonal relationship thereto, said second bracket disposed in overlying relationship to said first bracket with their base plates disposed generally parallel to each other with the lugs thereof projecting axially towards said post, the lug of said first bracket disposed in parallel, contacting engagement with the first lug of said second bracket with each of those lugs formed with respective apertures disposed in coaxial alignment and of lengths to position their base plates in closely spaced relationship, said second lug of said second bracket being of a substantial length and adapted to mechanically interengage with a component of a vehicle to be retained by said apparatus, said locking device comprising a shackle lock having a U-shaped shackle including a pair of shafts, one said shafts adapted to removably interfit through said lugs apertures.
